(19) United States
(12) Patent Application Publication
(10) Pub. No.: US 2026/0149202 A1
(43) Pub. Date: May 28, 2026

(54) MOUNTING BOARD AND ELECTRONIC APPARATUS

(71) Applicant: Lenovo (Singapore) Pte. Ltd., Singapore (SG)

(72) Inventors: Fumitake Mizoguchi, Kanagawa (JP); Yoshiyuki Shibayama, Kanagawa (JP); Hiroya Yagihashi, Kanagawa (JP); Makoto Hashikura, Kanagawa (JP)

(73) Assignee: Lenovo (Singapore) Pte. Ltd., Singapore (SG)

(21) Appl. No.: 19/373,949

(22) Filed: Oct. 30, 2025

(30) Foreign Application Priority Data
Nov. 27, 2024 (JP) 2024-206323

(51) Int. Cl. H01R 12/71

(52) U.S. Cl. CPC H01R 12/716

(57) ABSTRACT

A mounting board includes a board-mounted connector including a connector connection hole extending along a surface normal direction of a board to be open outward and being mounted on a top surface of the board, a receptacle connector including a plug holding cylinder to which a plug is connected, a relay connector that is detachably connected to the connector connection hole, and a body, and a guiding inclined surface gradually leaning downward from an inside to an outside on a top of the board. An opening edge of the connector connection hole is open so that the relay connector is able to be inserted in an angular range from a top outside to a horizon, and when the relay connector is inserted and then is inclined to become horizontal, the receptacle connector is guided outward by an inside end of the body slidingly contacting the guiding inclined surface.

### CROSS-REFERENCE TO RELATED APPLICATIONS

This application claims priority to Japanese Patent Application No. 2024-206323 filed on Nov. 27, 2024, the contents of which are hereby incorporated herein by reference in their entirety.

### BACKGROUND

### Technical Field

The present invention relates to a mounting board including a receptacle connector and an electronic apparatus including the mounting board.

### Description of the Related Art

A mounting board of a laptop PC, a tablet PC, or the like includes a receptacle connector as an I/O connector on a side surface of a flat chassis. The receptacle connector is often mounted on an edge of a main board (see Japanese Unexamined Patent Application Publication No. 2019-36484).

Recently, it is expected that the mounting board as described above is a product excellent in maintainability from the viewpoint of ESG (Environment, Social, Governance). From this viewpoint, it is desirable that the receptacle connector can easily exchange. Especially, when the receptacle connector is based on the frequently used USB Type-C standard etc., there are a large number of failures and thus it is further desirable that the receptacle connector can easily exchange.

In this regard, the receptacle connector itself is relatively inexpensive. However, when the receptacle connector is mounted on the main board by soldering, the main board must be exchanged to exchange the connector. As a result, this increases the cost burden of a user and also affects environmental performance.

### SUMMARY

One or more embodiments provide a mounting board and an electronic apparatus, which can easily exchange the receptacle connector.

A mounting board according to a fist aspect of one or more embodiments has a component mounted on a board thereof, the mounting board including: a board-mounted connector including a connector connection hole having a contact provided on an inner surface thereof and extending along a surface normal direction of the board to be open outward, the board-mounted connector being mounted on a top surface of the board; a receptacle connector including a plug holding cylinder to which a plug is connected, a relay connector that is detachably connected to the connector connection hole, and a body outside which the plug holding cylinder is provided, the relay connector protruding from an inside thereof; and a guiding inclined surface provided on a top of the board near an opening edge of the connector connection hole, the guiding inclined surface inclining downward toward an outside direction, wherein the opening edge of the connector connection hole is open so that the relay connector is able to be inserted in an angular range from a top outside to a horizon, and when the relay connector is inserted into the opening edge from the top outside and then is inclined to become horizontal, the receptacle connector is guided outward by a portion of the body slidingly contacting the guiding inclined surface.

An electronic apparatus according to a second aspect of one or more embodiments includes a mounting board that has a component mounted on a board thereof, the electronic apparatus including: a board-mounted connector including a connector connection hole having a contact provided on an inner surface thereof and extending along a surface normal direction of the board to be open outward, the board-mounted connector being mounted on a top surface of the board; a receptacle connector including a plug connection port to which a plug is connected, a relay connector that is detachably connected to the connector connection hole, and a body outside which the plug connection port is provided, the relay connector protruding from an inside thereof; and a guiding inclined surface provided on a top of the board near an opening edge of the connector connection hole, the guiding inclined surface inclining downward toward an outside direction, wherein the opening edge of the connector connection hole is open so that the relay connector is able to be inserted in an angular range from a top outside to a horizon, and when the relay connector is inserted into the opening edge from the top outside and then is inclined to become horizontal, the receptacle connector is guided outward by a portion of the body slidingly contacting the guiding inclined surface.

The above-described aspects of one or more embodiments can easily exchange the receptacle connector.

### BRIEF DESCRIPTION OF THE DRAWINGS

FIG. 1 is a perspective diagram illustrating an electronic apparatus according to one or more embodiments;

FIG. 2 is a perspective diagram illustrating a receptacle connector and a board-mounted connector as viewed obliquely from above and outside;

FIG. 3 is a perspective diagram illustrating the board-mounted connector;

FIG. 4 is a perspective diagram illustrating the receptacle connector;

FIG. 5 is a schematic side sectional view illustrating the receptacle connector, the board-mounted connector, and a chassis in the peripheral area;

FIG. 6 is a schematic side sectional view illustrating a state in which the receptacle connector is attached to the board-mounted connector;

FIG. 7 is a schematic partial sectional side view explaining an operation of attaching the receptacle connector to the board-mounted connector; and

FIGS. 8A to 8D are diagrams explaining an operation of attaching the receptacle connector to the board-mounted connector, in which FIG. 8A is a diagram illustrating a relay connector angled at 30 degrees in an initial stage, FIG. 8B is a diagram illustrating the relay connector angled at 20 degrees in an intermediate stage, FIG. 8C is a diagram illustrating the relay connector angled at 10 degrees in the intermediate stage, and FIG. 8D is a diagram illustrating the relay connector angled at 0 degrees in a final stage.

### DESCRIPTION OF THE EMBODIMENTS

Hereinafter, a mounting board according to one or more embodiments will be described in detail with reference to the accompanying drawings. Note that the embodiments disclosed below are not intended to limit the present invention.

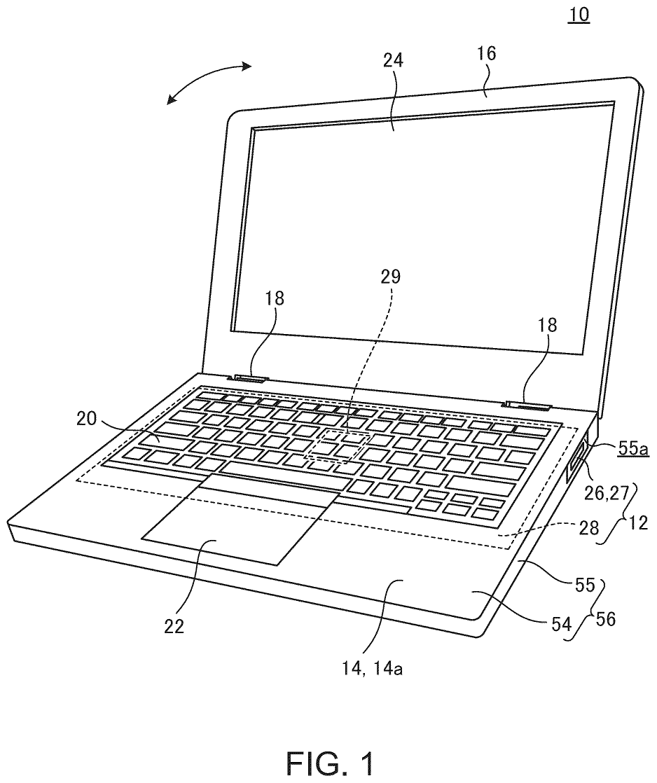

FIG. 1 is a perspective diagram illustrating an electronic apparatus 10 according to one or more embodiments. The electronic apparatus 10 is equipped with a mounting board 12 according to one or more embodiments. The mounting board 12 is incorporated inside a chassis 14 of the electronic apparatus 10. Hereinafter, one or more embodiments will be described by exemplifying the electronic apparatus 10 that is a laptop PC. One or more embodiments can be also applied to an electronic apparatus other than the laptop PC, for example, a desktop PC, a tablet PC (tablet terminal), and the like.

The electronic apparatus 10 includes the chassis 14, a cover body 16, and a hinge 18. The chassis 14 and the cover body 16 are connected by the hinge 18 to be rotatable relative to each other.

The chassis 14 is provided with a keyboard 20 and a touch pad 22. Not only the mounting board 12 but also various types of electronic components such as a battery device, a storage device, a speaker, and an antenna can be equipped inside the chassis 14. A display device 24 is provided on a front surface of the cover body 16, which occupies most of an area thereof. The display device 24 can be configured as a liquid crystal display, an organic electroluminescence display, or the like, for example. The cover body 16 can be also equipped with a speaker, a camera, and the like.

The mounting board 12 is supported inside the chassis 14. The mounting board 12 can include a receptacle connector 26, a board-mounted connector 27, and a board 28. The mounting board 12 is a connector/board assembly in which the receptacle connector 26 is mounted on the board 28 via the board-mounted connector 27.

The board 28 is a main board (motherboard) of the electronic apparatus 10. The board 28 is a printed circuit board (PCB). The board 28 extends across substantially the left/right both ends inside the chassis 14. The board 28 is mounted with a component such as a CPU 29 that controls the entire of the electronic apparatus 10. The board-mounted connector 27 is mounted on the board 28. The receptacle connector 26 is mounted on the board 28 via the board-mounted connector 27. The board 28 on which the board-mounted connector 27 is mounted may be a sub-board different from the main board.

For convenience of explanation, around the receptacle connector 26, the lateral side of the chassis 14 is set to an outside, and conversely, the inside of the chassis 14 is set to an inside. Moreover, by using the board 28 as a reference, a mounting surface (top surface) 28a on which the board-mounted connector 27 is mounted is set to top, and the opposite side is set to bottom. This reference for top and bottom may be reversed from the top and bottom of the chassis 14 illustrated in FIG. 1. In other words, when the top and bottom using the board 28 as a reference is applied to the chassis 14, a surface on which the keyboard 20 is provided may be the bottom. For the receptacle connector 26 and the board-mounted connector 27, a direction perpendicular to an inward/outward direction and a top/bottom direction is set to a width direction. The designation for these directions is used for convenience of explanation, and the method of use of the electronic apparatus 10 is not limited to this. Most of components on the board 28 are mounted on the mounting surface 28a, but some components may be mounted on a back surface 28b.

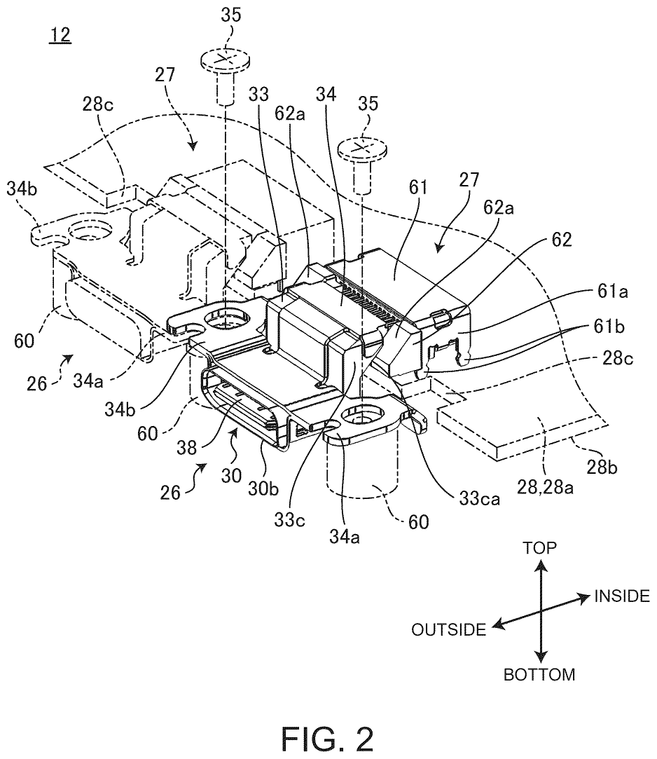

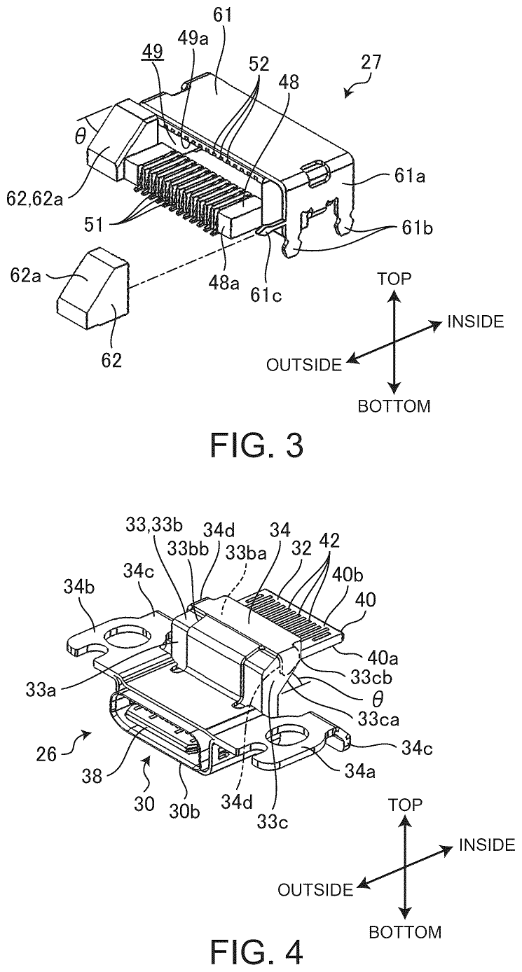

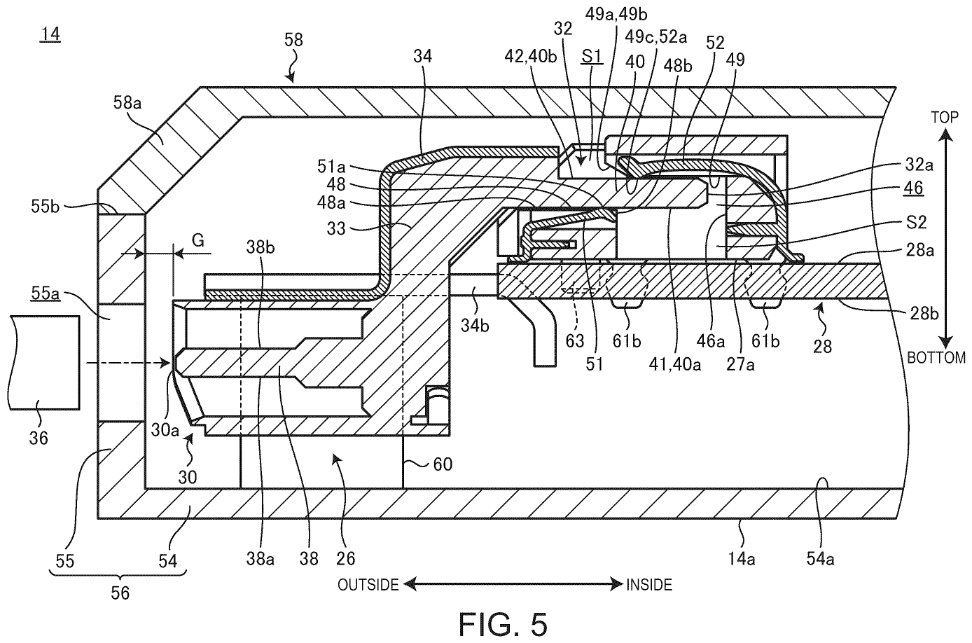

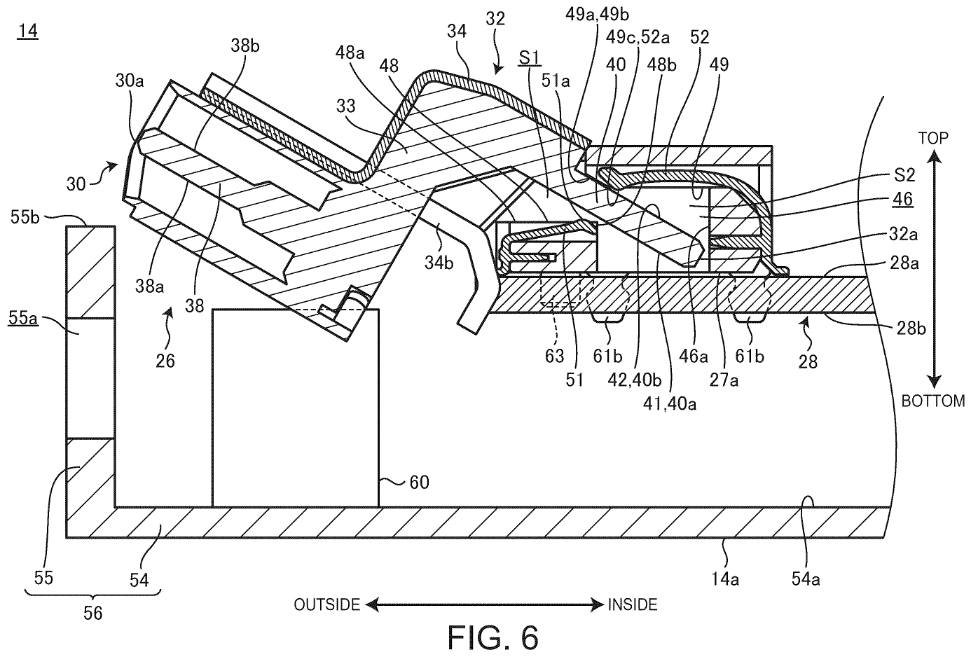

FIG. 2 is a perspective diagram illustrating the receptacle connector 26 and the board-mounted connector 27 as viewed obliquely from above and outside. FIG. 3 is a perspective diagram illustrating the board-mounted connector 27. FIG. 4 is a perspective diagram illustrating the receptacle connector 26. FIG. 5 is a schematic side sectional view illustrating the receptacle connector 26, the board-mounted connector 27, and the chassis 14 in the peripheral area. FIG. 6 is a schematic side sectional view illustrating a state in which the receptacle connector 26 is attached to the board-mounted connector 27.

First, a configuration example of the receptacle connector 26 will be described. As illustrated in FIGS. 2 to 6, the receptacle connector 26 is a connector based on the USB Type-C standard, for example. The receptacle connector 26 can be used for data transmission and charging. The receptacle connector 26 may be based on the HDMI (registered trademark) standard etc. The receptacle connector 26 is mounted on the board 28 via the board-mounted connector 27. As a result, the receptacle connector 26 can be attached and detached without being soldered to the board 28.

The receptacle connector 26 includes a plug holding cylinder 30, a relay connector 32, a body 33, and a bracket 34. The receptacle connector 26 is connected to the board-mounted connector 27 mounted on the mounting surface 28a. The receptacle connector 26 has a crank shape, but this shape depends on a layout condition based on the positions of the board 28 and a connector hole 55a.

The body 33 is made of resin, and includes a vertical plate 33a, a top plate 33b, and two triangular plates 33c. The vertical plate 33a is located immediately outside the board 28, and is located across the top and bottom of the board 28. The plug holding cylinder 30 is provided on the outside of a bottom end of the vertical plate 33a. The top plate 33b is a short plate in the inward/outward direction, and is provided from a top end of the vertical plate 33a toward the inside. The relay connector 32 protrudes inward from the top plate 33b. The relay connector 32 has a width dimension slightly smaller than that of the body 33.

Each of the triangular plates 33c is a small plate provided across the vertical plate 33a and the top plate 33b at both ends of the body 33 in the width direction. The top plate 33b forms a horizontal surface 33ba on substantially one-half of the inside and a gentle inclined surface 33bb on substantially one-half of the outside. An inside diagonally downward portion of the triangular plate 33c forms a guided inclined surface 33ca.

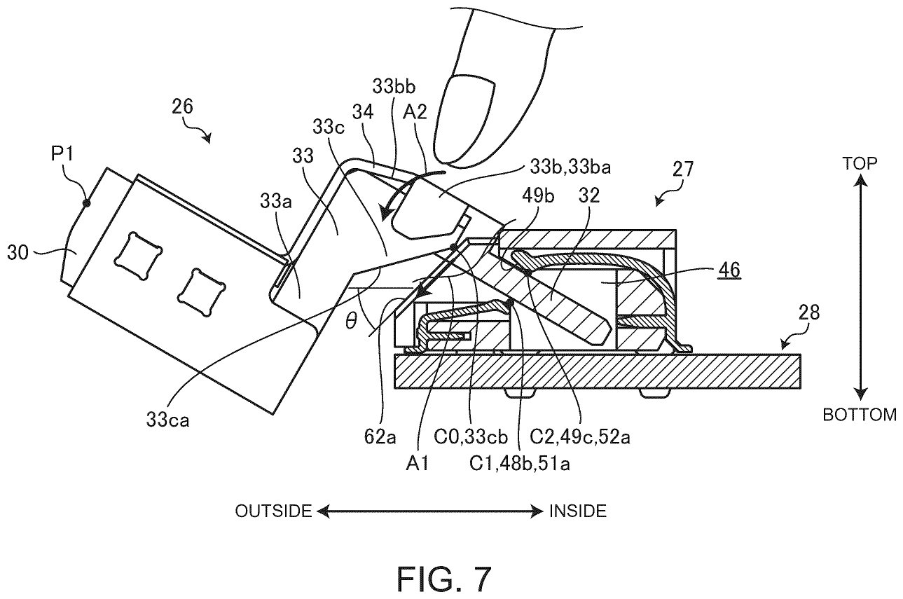

The guided inclined surface 33ca gradually leans downward from the inside to the outside, and has an inclination angle 0 of 45 degrees using a horizon as a reference. The triangular plate 33c hardly overlaps the relay connector 32 in the width direction. In a side view (also see FIG. 7), the outside of the guided inclined surface 33ca arrives up to the vertical plate 33a, and the inside is formed up to an inside end (initial abutment) 33cb. The inside end 33cb is located at substantially the same position as the inside surface of the top plate 33b. The width dimension of the triangular plate 33c and the guided inclined surface 33 ca is about 2.4 mm, for example. The length of the guided inclined surface 33ca along a diagonal direction is about 2.6 mm, for example.

The plug holding cylinder 30 is a metallic cylindrical body. The plug holding cylinder 30 has a flattened elliptical shape with four rounded corners. The plug holding cylinder 30 is located at the outermost side of the receptacle connector 26, and is located lower than the relay connector 32.

The connector hole 55a is formed in a standing wall 55 that forms a side surface of the chassis 14 (also see FIG. 1). The plug holding cylinder 30 is placed opposite to the connector hole 55a. As a result, a plug connection port 30a of the plug holding cylinder 30 is exposed to the outside of the chassis 14 through the connector hole 55a. The plug connection port 30a enables to insert and connect a plug 36 (see FIG. 5). The plug 36 is a plug connector mounted on a cable or a device. The connection standard between the plug connection port 30a and the plug 36 is based on the USB Type-C standard, for example. The plug 36 can be inserted into and connected to the plug connection port 30a regardless of the top or bottom direction. The bottom half of the plug connection port 30a is slightly inclined.

A tongue-shaped plate piece 38 is provided in the plug holding cylinder 30. Contacts 38a and 38b are respectively provided on a bottom surface and a top surface of the plate piece 38. A terminal of the plug 36 contacts with the contacts 38a and 38b. Each of the contacts 38a and 38b is made of a plurality of metallic pins arranged in parallel in the width direction of the plate piece 38. The contacts 38a and 38b are respectively connected to terminals 41 and 42 of the relay connector 32 via the body 33 by using respective electrode lines. Each of “the contacts 38a and 38b” and “the terminals 41 and 42” has 24 metallic pins, for example.

The relay connector 32 is located on the innermost side of the receptacle connector 26. The relay connector 32 is located over the mounting surface 28a. The relay connector 32 can have a plug structure. The relay connector 32 can be detachably connected to a connector connection hole 46 of the board-mounted connector 27.

The relay connector 32 can include a tongue-shaped plate piece 40, the first terminal 41 provided on a bottom surface 40a of the plate piece 40, and the second terminal 42 provided on a top surface 40b of the plate piece 40. Each of the terminals 41 and 42 is made of a plurality of metallic pins arranged in parallel in the width direction of the plate piece 40, for example. Each of the terminals 41 and 42 has 12 metallic pins, for example.

The bracket 34 is a thin sheet metal part. The bracket 34 covers an outer peripheral surface excluding the plug connection port 30a of the plug holding cylinder 30, an outer surface of the vertical plate 33a, and a top surface of the top plate 33b. The bracket 34 includes a pair of fixing pieces 34a and 34b in the width direction. The fixing pieces 34a and 34b protrude from a side surface of the plug holding cylinder 30 in opposite directions with respect to each other. The fixing pieces 34a and 34b can be used for fixing the receptacle connector 26 to the board 28. A screw through-hole is formed in each of the fixing pieces 34a and 34b. The fixing piece 34a and the fixing piece 34b have slightly different heights, and when a plurality of the receptacle connectors 26 are arranged adjacent to each other as illustrated by the virtual lines in FIG. 2, a space can be effectively utilized by overlapping the one fixing piece 34a and the other fixing piece 34b. Fin pieces 34c protrude from the fixing pieces 34a and 34b toward the inside diagonally downward portion. Notches 28c (see FIG. 2) avoiding the fin pieces 34c are formed on the board 28. The bracket 34 includes a pair of claws 34d in the width direction. The claws 34d hold side surfaces of the top plate 33b and the triangular plate 33c.

A plate portion 54 forming an inner surface of the chassis 14 is formed with a stud 60 that stands up (see FIG. 5). A female screw is formed to be opened on an apex surface of the stud (fixing portion) 60. Screws 35 passed through the screw through-holes of the fixing pieces 34a and 34b are threaded with the female screw of the stud 60. As a result, the receptacle connector 26 is fixed to the chassis 14 in a state where the relay connector 32 is located in a horizontal orientation.

Next, a configuration example of the board-mounted connector 27 will be described. As illustrated in FIGS. 2 to 6, the board-mounted connector 27 can be mounted by fixing a connection surface 27a to the mounting surface 28a of the board 28 by soldering. The board-mounted connector 27 can detachably connect the relay connector 32 of the receptacle connector 26. Because the relay connector 32 has a plug structure in one or more embodiments, the board-mounted connector 27 has a socket structure.

The board-mounted connector 27 includes the connector connection hole 46. The connector connection hole 46 extends along a surface normal direction of the board 28 and is open toward the outside. An opening edge of the connector connection hole 46 includes a first edge 48a and a second edge 49a. The first edge 48a is an edge on the mounting surface 28a side (the bottom). The second edge 49a is an edge on an opposite side (the top) to the mounting surface 28a side. The edges 48a and 49a extend in the width direction of the connector connection hole 46.

Terminals 51 and 52 are provided on an inner surface of the connector connection hole 46. The terminals 51 and 52 respectively contact with the terminals 41 and 42 of the relay connector 32 to be electrically connected to each other. One of a combination of the bottom terminal 51 and the terminal 41 and a combination of the top terminal 52 and the terminal 42 may be omitted. The board-mounted connector 27 and the relay connector 32 may be electrically connected via an elastic contact between a rear surface 46a and a tip surface 32a.

The inner surface of the connector connection hole 46 has a first inner surface 48 and a second inner surface 49. The first inner surface 48 corresponds to a bottom surface of the connector connection hole 46. The first inner surface 48 extends from the first edge 48a toward the inside of the connector connection hole 46 in the inward/outward direction. The second inner surface 49 corresponds to a top surface of the connector connection hole 46. The second inner surface 49 extends from the second edge 49a toward the inside of the connector connection hole 46 in the inward/outward direction.

The first terminal 51 is provided so that a bottom contact 51a is exposed on the first inner surface 48. The second terminal 52 is provided so that a top contact 52a is exposed on the second inner surface 49. The contacts 51a and 52a of the terminals 51 and 52 respectively contact with the terminals 41 and 42 of the relay connector 32 to be electrically connected. The terminals 51 and 52 are respectively connected to signal lines or ground patterns formed on the board 28. Each of the terminals 51 and 52 is made of a plurality of metallic pins arranged in parallel in the width direction of the connector connection hole 46. Each of the terminals 51 and 52 has 12 metallic pins, for example.

As illustrated in FIG. 5, the second edge 49a is offset inward from the first edge 48a in the inward/outward direction of the connector connection hole 46. Conversely, the first edge 48a is offset outward from the second edge 49a in the inward/outward direction of the connector connection hole 46. Therefore, in the connector connection hole 46, the first edge 48a that is a bottom jaw protrudes outward than the second edge 49a that is a top jaw. As a result, the opening edge of the connector connection hole 46 forms an open space S1 whose top is open. The open space S1 is a space that permits a base portion of the relay connector 32 inserted into the connector connection hole 46 to vertically swing.

The second edge 49a facing the open space S1 has an inclined surface 49b. The inclined surface 49b is gradually inclined (upward) away from the mounting surface 28a from the inside to the outside of the connector connection hole 46. The inclination angle of the inclined surface 49b with respect to the surface normal direction of the board 28 is not limited, but it can be set to, for example, about 30 to 40 degrees with respect to the horizontal reference. The inclination angle in one or more embodiments is about 30 degrees. The inclination angle of the inclined surface 49b can be designed in consideration of the vertical height of the receptacle connector 26, the standing height of the standing wall 55 to be described later, and the like.

The connector connection hole 46 can have an expansion space S2 formed by hollowing a portion of the first inner surface 48 located at the inside of the first contact 51a toward the mounting surface 28a side (the bottom). The expansion space S2 is a space obtained by downward expanding the rear portion of the connector connection hole 46. The expansion space S2 is a space that permits the tip portion of the relay connector 32 inserted into the connector connection hole 46 to downward swing.

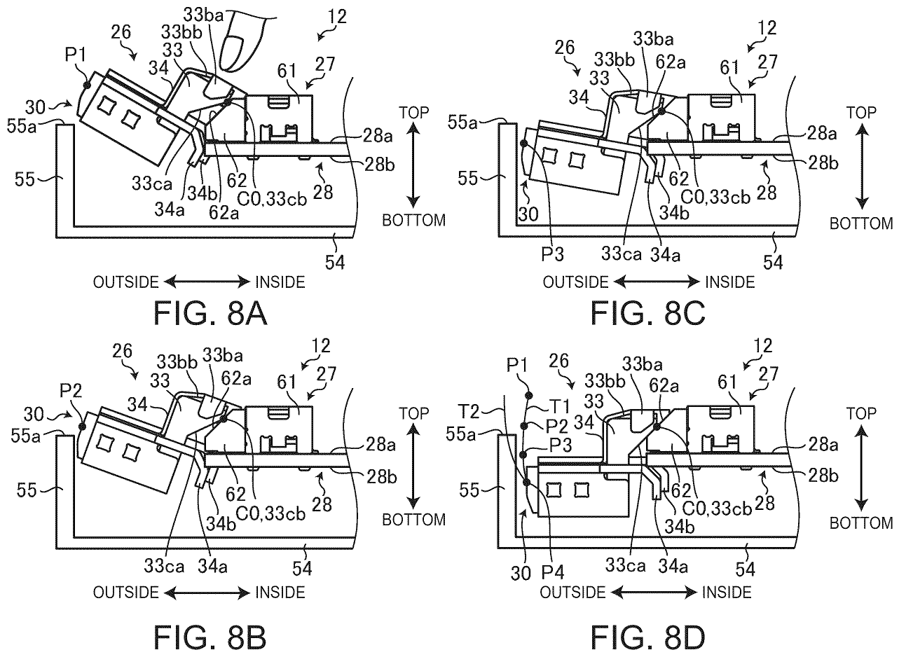

At the opening edge of the connector connection hole 46, the first inner surface 48 forms a bottom inside end 48b and the second inner surface 49 forms a top outside end 49c. The top outside end 49c corresponds to a bottom end of the inclined surface 49b. The bottom inside end 48b and the top outside end 49c are near to each other, but the top outside end 49c is offset inward from the bottom inside end 48b in the inward/outward direction, and thus the relay connector 32 can be diagonally inserted (see FIG. 5). Moreover, the relay connector 32 diagonally inserted into the opening edge of the connector connection hole 46 can be inclined up to a horizontal position by a human hand (see FIGS. 8A to 8D). In other words, the opening edge of the connector connection hole 46 is open so that the relay connector 32 can be inserted in an angular range from the top outside to the horizon.

The bottom contact 51a is located near the bottom inside end 48b, and can be slightly elastically displaced downward by the contact with the terminal 41 due to the spring property of the terminal 51. The bottom contact 51a and the bottom inside end 48b are sufficiently near to each other, and are collectively called a bottom reference point C1 (see FIG. 7). The top contact 52a is located near the top outside end 49c, and can be slightly elastically displaced upward by the contact with the terminal 42 due to the spring property of the terminal 52. The top contact 52a and the top outside end 49c are sufficiently near to each other, and are collectively called a top reference point C2 (see FIG. 7). The bottom reference point C1 and the top reference point C2 are located to substantially have contact with the relay connector 32 inserted diagonally (see FIGS. 8A to 8D).

The board-mounted connector 27 includes a metal shell 61 that covers a top surface and both side surfaces thereof. The metal shell 61 includes side plates 61a on both sides, two leg parts 61b protruding downward from each of the side plates 61a, and protrusions 61c protruding outside from the side plates 61a. Each of the leg parts 61b is inserted into a through-hole of the board 28 and is soldered to it, and is reliably fixed to it and is electrically connected to ground. In other words, the metal shell 61 has a shielding effect. The tip of each of the protrusions 61c has an arrowhead shape. The metal shell 61 is stabilized because the four leg parts 61b are fixed to the board, and thus the protrusion 61c is also stabilized. Each of the protrusions 61c is mounted with an inclined table 62 that has a guiding inclined surface 62a. The inclined table 62 mounted on the protrusion 61c is provided near the opening edge of the connector connection hole 46 at the top of the board 28.

The inclined table 62 is made of resin, has a substantially right-angled triangle in a side view, and includes the guiding inclined surface 62a formed at the outside and top. In the inclined table 62, a bottom surface thereof abuts on the mounting surface 28a of the board 28 and an inside surface thereof abuts on the edge of the side plate 61a to be stabilized. A hole into which the protrusion 61c is fitted is formed in the inside surface of the inclined table 62. The inclined table 62 is symmetrical in the width direction around the protrusion 61c and has preferable balance. The guiding inclined surface 62a gradually leans downward from the inside to the outside, and the inclination angle e using the horizon as a reference is 45 degrees. In other words, the guiding inclined surface 62a and the guided inclined surface 33ca have the equal inclination angle. The two guiding inclined surfaces 62a have chamfered edges on sides that are close to each other.

The height of the inclined table 62 is substantially equal to the height of the metal shell 61 from the mounting surface 28a. The width of the inclined table 62 in the inward/outward direction is substantially equal to the height. Note that the width dimension of the metal shell 61 is substantially equal to the plug holding cylinder 30 and thus is not required to be particularly large to mount the inclined table 62. The width dimension of the inclined table 62 is small and is about 2.0 mm for example, and thus the inclined table does not interfere with at least the fin piece 34c. The board-mounted connector 27 includes a positioning pin 63 that protrudes downward (see FIG. 6). The positioning pin 63 is inserted into a positioning hole formed in the board 28 to perform positioning.

As illustrated in FIG. 5, the chassis 14 can include a chassis member 56, which has the plate portion 54 and the standing wall 55, and a cover member 58.

The chassis member 56 can have a shallow bathtub shape by forming the standing wall 55 on the outer peripheral edge of the plate portion 54. The plate portion 54 forms an operating surface 14a of the chassis 14. The operating surface 14a is a surface on which the keyboard 20 and the touch pad 22 are exposed (see FIG. 1). The stud 60 can be formed to stand on an inner surface 54a of the plate portion 54. The stud 60 is arranged at a position corresponding to at least the two fixing pieces 34a and 34b. As described above, the stud 60 can be used for fastening the receptacle connector 26. The board 28 is appropriately supported with respect to the inner surface 54a of the plate portion 54 also in a portion other than the perimeter of the receptacle connector 26.

The standing wall 55 stands up toward the top from the outer peripheral edge of the plate portion 54. The connector hole 55a is formed in the standing wall 55 that forms the side surface of the chassis 14 (also see FIG. 1). The connector hole 55a faces the plug connection port 30a of the receptacle connector 26. The connector hole 55a is an opening for connecting the plug 36 to the plug connection port 30a.

The cover member 58 is a plate-shaped member that closes an opening of the chassis member 56. An edge of the cover member 58 can be provided with a tapered portion 58a. The tapered portion 58a is inclined from a tip (top end 55b) to the inside of the standing wall 55. The receptacle connector 26 can be arranged so that top and bottom steps between the relay connector 32 and the plug holding cylinder 30 wrap around the inner surface of the tapered portion 58a.

As illustrated in FIG. 5, the receptacle connector 26 can be mounted on the board 28 via the board-mounted connector 27, and can be supported on the chassis 14 via the fixing pieces 34a and 34b and the stud 60. The receptacle connector 26 may be fixed to the board 28 by screws at locations other than the fixing pieces 34a and 34b. In this state, a predetermined gap G can be provided between an open end 30b of the plug connection port 30a and the inner surface of the standing wall 55. The gap G is an opposing distance between the standing wall 55 and the plug connection port 30 a. The gap G may be 0.2 mm, for example. The gap G may be substantially zero.

Next, an attachment operation and its effects of the receptacle connector 26 will be described. FIG. 7 is a schematic partial sectional side view explaining an operation of attaching the receptacle connector 26 to the board-mounted connector 27. FIGS. 8A to 8D are diagrams explaining an operation of attaching the receptacle connector 26 to the board-mounted connector 27, in which FIG. 8A is a diagram illustrating the relay connector 32 angled at 30 degrees in an initial stage, FIG. 8B is a diagram illustrating the relay connector 32 angled at 20 degrees in an intermediate stage, FIG. 8C is a diagram illustrating the relay connector 32 angled at 10 degrees in the intermediate stage, and FIG. 8D is a diagram illustrating the relay connector 32 angled at 0 degrees in a final stage. FIG. 8A corresponds to FIGS. 6 and 7, and FIG. 8D corresponds to FIG. 5. Points P1 to P4 in FIGS. 8A to 8D are reference points for the operation of the receptacle connector 26, and are set on an extended portion of the plate piece 38 at the plug connection port 30a.

When attaching the receptacle connector 26 to the board-mounted connector 27, the cover member 58 is first removed from the chassis member 56. As a result, the inside of the chassis 14 is exposed. Then, as illustrated in FIGS. 6 and 7, the relay connector 32 is inserted into the connector connection hole 46 from the opening edge.

The relay connector 32 is inserted up to the rear of the expansion space S2 substantially along the inclined surface 49b until the inside end 33cb of the guided inclined surface 33ca abuts on the top of the guiding inclined surface 62a. The inside end 33cb first abuts on the guiding inclined surface. At this time, the tip surface 32a arrives to the vicinity of an intersection between the rear surface 46a and the mounting surface 28a. The bottom surface 40a of the plate piece 40 constituting the relay connector 32 has almost no gap with or has contact with the bottom reference point C1, and the top surface 40b has almost no gap with or has contact with the top reference point C2. Normally, the plate piece 40 has contact with at least one of the bottom reference point C1 and the top reference point C2. Moreover, the bottom contact 51a of the bottom reference point C1 and the top contact 52a of the top reference point C2 may elastically have contact with the plate piece 40. The inside end 33cb is an initial abutment on the guiding inclined surface 62a, and acts as a stopper that limits an insertion amount of the relay connector 32. The inside end 33cb is called an operation reference point C0 because the inside end acts as a reference for operation at least in the initial stage of the attachment operation of the receptacle connector 26.

At this time, the top plate 33b is located outside and above the operation reference point C0, and the horizontal surface 33ba and the gentle inclined surface 33bb are positioned and oriented to be easily operated by a human hand to be a pressing operation surface. Herein, because the horizontal surface 33ba and the gentle inclined surface 33bb are covered by the bracket 34 in one or more embodiments, the bracket 34 is a part that has substantially contact with the human hand. The horizontal surface 33ba is about 30 degrees as with the relay connector 32, and the gentle inclined surface 33bb is about 20 degrees.

Then, as illustrated in FIG. 7 and FIG. 8A, when pushing by hand the horizontal surface 33ba and the gentle inclined surface 33bb that are the pressing operation surface, a downward force is added toward the outside as in an arrow A1 because these surfaces are inclined, and the operation reference point C0 is guided diagonally downward by slidingly contacting the guiding inclined surface 62a. Moreover, because the pressing operation surface is located outside and above the operation reference point C0, a rotational force around the operation reference point C is also added to the receptacle connector 26 as illustrated by a circular arrow A2.

The inclination angle 0 of the guiding inclined surface 62a is 45 degrees as described above, and this is suitable for the operation reference point co to slidingly contact and be guided. A range of the inclination angle 0 suitable for the guiding inclined surface 62a to slidingly contact the operation reference point C0 and guide it diagonally downward is about 45 to 60 degrees by the horizontal reference.

With a displacement of the receptacle connector 26, because at least one of “the bottom contact 51a and the bottom inside end 48b” constituting the bottom reference point C1 and “the top contact 52a and the top outside end 49c” constituting the top reference point C2 abuts on and slidingly contacts the plate piece 40, the receptacle connector 26 can be assisted to move in a rotational manner without moving in parallel.

By doing so, as illustrated in FIG. 8B, the receptacle connector 26 is displaced diagonally downward and is totally rotated, and at this point, the relay connector 32 and the horizontal surface 33ba become about 20 degrees and the gentle inclined surface 33bb becomes about 10 degrees.

As illustrated in FIG. 8C, the receptacle connector 26 is further displaced diagonally downward and is totally rotated, and at this point, the relay connector 32 and the horizontal surface 33ba become about 10 degrees and the gentle inclined surface 33bb becomes about 0 degrees.

As illustrated in FIG. 8D, the receptacle connector 26 is further displaced diagonally downward and is totally rotated, and at this point, the relay connector 32 and the horizontal surface 33ba become 0 degrees, namely, horizontal and the gentle inclined surface 33bb becomes about −10 degrees. Because the relay connector 32 becomes horizontal, the bottom contact 51a elastically contacts with the terminal 41 and the top contact 52a elastically contacts with the terminal 42 to electrically connect them. Moreover, the guided inclined surface 33ca is in surface contact with the guiding inclined surface 62a to be stabilized. The guided inclined surface 33ca may slidingly contact the guiding inclined surface 62a from the intermediate stage. In other words, the guided inclined surface 33ca is in surface contact with the guiding inclined surface 62a until the relay connector 32 becomes horizontal. The fixing pieces 34a and 34b are placed on the stud 60 to be fixed by the screws 35, and the plug connection port 30a of the plug holding cylinder 30 faces the connector hole 55a.

The point P1 on the tip of the plug holding cylinder 30 in FIG. 8A moves to the point P2 in FIG. 8B, moves to the point P3 in FIG. 8C, and moves to the point P4 in FIG. 8D to draw a trajectory T1. The point P4 in the final stage is extremely near the standing wall 55, but, because the initial point P1 is slightly inward from the standing wall 55, the intermediate points P2 and P3 are located on a gentle circular arc that roughly connects the points P1 to P4 and thus do not interfere with the standing wall 55. If one or more embodiments have a mechanism that the receptacle connector 26 rotates around the operation reference point C0 in the final stage, namely, FIG. 8D, because the receptacle connector interferes with the standing wall 55 as illustrated by a trajectory T2, it is considered that complicated procedure and mechanism are required to avoid this. On the contrary, according to one or more embodiments, with one push operation of only pushing the pressing operation surface, the receptacle connector 26 can be arranged and attached at an appropriate position without interference.

The horizontal surface 33ba and the gentle inclined surface 33bb of the pressing operation surface are located above and outside the operation reference point C0 in the initial stage of FIG. 8A to be easily pressed, and are inclined upward toward the outside to easily add a force in an appropriate direction. Moreover, because it becomes horizontal up to the final stage of FIG. 8D, it is easy to intuitively understand the operation.

Up to this point, there has been described an example of attaching the receptacle connector 26 to the board-mounted connector 27, but the reverse procedure can be performed when removing and exchanging the damaged receptacle connector 26, for example. Of course, in the case of removing, the receptacle connector 26 does not interfere with the standing wall 55.

When removing the receptacle connector 26, the screws 35 are first removed from the fixing pieces 34a and 34b fixed to the stud 60. By doing so, because the plate piece 40 receives an elastic force from the contacts 51a and 52a at top/bottom and front/rear offset positions, a clockwise small rotational force is generated. Therefore, the receptacle connector 26 can slightly rotate automatically, and the plug holding cylinder 30 can pop up to lift up and be easily picked up. As described above, according to one or more embodiments, the receptacle connector 26 can be easily exchanged. Moreover, it is not required to exchange the board 28 itself to exchange the receptacle connector 26, and thus the cost burden on the user is reduced and environmental performance is improved.

The present invention is not limited to the embodiments described above, and can be freely modified without departing from the spirit of the present invention.

### Description of Symbols

10 electronic apparatus
12 mounting board
14 chassis
26 receptacle connector
27 board-mounted connector
28 board
30 plug holding cylinder
30a plug connection port
32 relay connector
33 body
33ba horizontal surface
33bb gentle inclined surface
33c triangular plate
33ca guided inclined surface
33cb inside end (initial abutment)
38a, 38b, 51a, 52a contact
41, 42, 51, 52 terminal
46 connector connection hole
48b bottom inside end
49b inclined surface
49c top outside end
55 standing wall
55a connector hole
60 stud
61 metal shell
62 inclined table
62a guiding inclined surface

1. A mounting board having a component mounted on a board thereof, the mounting board comprising:
a board-mounted connector including a connector connection hole having a contact provided on an inner surface thereof and extending along a surface normal direction of the board to be open outward, the board-mounted connector being mounted on a top surface of the board;
a receptacle connector including a plug holding cylinder to which a plug is connected, a relay connector that is detachably connected to the connector connection hole, and a body outside which the plug holding cylinder is provided, the relay connector protruding from an inside thereof; and
a guiding inclined surface provided on a top of the board near an opening edge of the connector connection hole, the guiding inclined surface inclining downward toward an outside direction, wherein
the opening edge of the connector connection hole is open so that the relay connector is able to be inserted in an angular range from a top outside to a horizon, and
when the relay connector is inserted into the opening edge from the top outside and then is inclined to become horizontal, the receptacle connector is guided outward by a portion of the body slidingly contacting the guiding inclined surface.

2. The mounting board according to claim 1, wherein
the body has a guided inclined surface with a same inclination as that of the guiding inclined surface, and
when the relay connector is inserted into the opening edge from the top outside, an initial abutment first abuts on and then slidingly contacts the guiding inclined surface, and the guided inclined surface is in surface contact with the guiding inclined surface until the relay connector is inclined to become horizontal.

3. The mounting board according to claim 1, wherein
the opening edge of the connector connection hole forms a bottom inside end and a top outside end,
the top outside end is offset inward from the bottom inside end in an inward/outward direction,
the contact consists of at least one of a bottom contact that is elastically displaceable downward near the bottom inside end and a top contact that is elastically displaceable upward near the top outside end, and
at least one of the bottom inside end, the top outside end, the bottom contact, and the top contact abuts on the relay connector when the relay connector is inserted into the opening edge from the top outside and then is inclined to become horizontal.

4. The mounting board according to claim 3, further comprising:
a fixing portion fixing the receptacle connector in a state where the relay connector is located in a horizontal orientation, wherein
the relay connector is elastically biased and inclined by the contact by releasing the receptacle connector from fixing to the fixing portion.

5. The mounting board according to claim 1, wherein
the board-mounted connector includes a metal shell that covers a top surface and both side surfaces thereof,
a protrusion protrudes outward from a side plate of the metal shell, and
an inclined table forming the guiding inclined surface is mounted on the protrusion.

6. An electronic apparatus including a mounting board that has a component mounted on a board thereof, the electronic apparatus comprising:
a board-mounted connector including a connector connection hole having a contact provided on an inner surface thereof and extending along a surface normal direction of the board to be open outward, the board-mounted connector being mounted on a top surface of the board;
a receptacle connector including a plug connection port to which a plug is connected, a relay connector that is detachably connected to the connector connection hole, and a body outside which the plug connection port is provided, the relay connector protruding from an inside thereof; and
a guiding inclined surface provided on a top of the board near an opening edge of the connector connection hole, the guiding inclined surface inclining downward toward an outside direction, wherein
the opening edge of the connector connection hole is open so that the relay connector is able to be inserted in an angular range from a top outside to a horizon, and
when the relay connector is inserted into the opening edge from the top outside and then is inclined to become horizontal, the receptacle connector is guided outward by a portion of the body slidingly contacting the guiding inclined surface.
